(19) United States
(12) Patent Application Publication
(10) Pub. No.: US 2015/0288780 A1
(43) Pub. Date: Oct. 8, 2015

(54) Profile Evaluation System For Online Dating And Social Networking Websites

(71) Applicant: Antoine El Daher, Kenmore, WA (US)

(72) Inventor: Antoine El Daher, Kenmore, WA (US)

(21) Appl. No.: 14/246,072

(22) Filed: Apr. 5, 2014

(51) Int. Cl. H04L 29/08

(52) U.S. Cl. CPC H04L 67/306

(57) ABSTRACT

A method for allowing users on social networking websites, online dating websites, business networking websites, or other profile-based websites, to submit multiple profile variants of themselves and have them automatically evaluated. In its main embodiment, a first user submits multiple profile variants of himself to the server. Whenever a second user attempts to view the first user's profile on the website, the server selects one of the profile variants of the first user and shows it to the second user. The server and system also monitor the second user's behavior and engagement on this profile variant and records it in its database. After being viewed by multiple users, the first user can now compare how well each of his profile variants is doing and select the best one—it is also possible for him or the server to automatically predict the most suitable profile for each kind of visitor. This method is an easy way for a user to try out multiple profiles and actually get numeric proof as to which ones are performing the best.

### BACKGROUND

### Prior Art

The following is a tabulation of some prior art that presently appears relevant to this application:

### U.S. Patents and Applications

| Pat. No. | Issue/Publication Date | First Patentee or Assignee |
|---|---|---|
| 6,480,885 | Nov. 12, 2002 | Michael Olivier |
| 7,454,357 | Nov. 18, 2008 | Eharmony, Inc. |
| 7,669,123 | Aug. 11, 2006 | Facebook, Inc. |
| 7,725,492 | May 25, 2006 | Facebook, Inc. |
| 7,917,448 | Mar. 29, 2011 | Yahoo! Inc. |
| 8,060,463 | Nov. 15, 2011 | Amazon Technologies, Inc. |
| 8,566,327 | Oct. 22, 2013 | Choi |
| 8,583,563 | Nov. 12, 2013 | Carrico |
| 20050021750 | Jan. 27, 2005 | Friendster Inc., A California |
| | | Corporation |
| 20060059147 | Mar. 16, 2006 | Yahoo! Inc. |
| 20060085419 | Apr. 20, 2006 | Rosen James S |
| 20060106780 | May 18, 2006 | Ofer Dagan |
| 20060173963 | Aug. 3, 2006 | Microsoft Corporation |
| 20070073687 | Mar. 29, 2007 | Match.Com, L.P. |
| 20070073803 | Mar. 7, 2007 | Match.Com, L.P. |
| 20070192106 | Aug. 16, 2007 | Signal Match Inc. |
| 20080294624 | Nov. 27, 2008 | Ontogenix, Inc. |
| 20080301118 | Dec. 4, 2008 | Shu-Yao Chien |
| 20090106043 | Apr. 23, 2009 | Eharmony, Inc. |
| 20100293476 | Nov. 18, 2010 | Radius Dating LLC |
| 14/244,904 | N/A | El Daher |

### Non-Patent Literature

Analysis of user keyword similarity in online social networks—Bhattacharyya et al., Jun. 3, 2010

Item-Based Collaborative Filtering Recommendation Algorithms—Sarwar et al.

Over the past few years, the Internet has seen a rise in the number of websites available. One type of such websites are online dating and social networking websites. These websites are designed to allow human users to post information about themselves, in what is called a profile. The profile typically contains one or more traits that the user has. Such traits include but are not limited to: age, gender, pictures of the user, and possibly profession, work experience and physical address. We interchangeably refer to those user traits hereafter as characteristics or properties. Those profiles can serve a variety of purposes: in online dating, the profiles give other users of the website a general idea of what the user looks like and allows those other people to decide whether they think the user would be a good romantic match for them. In social networking, the profile is put up to allow friends and family to see it, and let them keep in touch with the user through e-mail, messaging, or other means. In business online networks, the profile can serve as a resume to allow other professionals, recruiters or companies to evaluate the user and potentially consider him as a candidate for a job opening.

In nearly all of the situations described above, the human user creates a page that he believes will best portray him in the online community that he joined, and allow him to achieve certain goals: for example, finding a romantic partner in online dating, getting a job offer in business networks, and so on. There are several other situations where websites are advertising users' profiles, and several websites where the users are the main product of the website. With the rise of social networking, these websites are becoming more and more dominant.

One issue that a lot of users seem to suffer from is creating high-quality profiles that can actually allow them to achieve their goals. For example, in an online business networking site, the user may create the best profile that he thinks he can make based on his experience, but a recruiter or someone with hiring experience might look at it and think it is lacking in quality. Recruiters and hiring managers in this example have a much better understanding of what makes a profile desirable to their company, and can provide valuable advice to the original user about modifications to make

In online dating, a user may take pictures and write a profile of himself thinking it is good, only to be found bad by the people he is trying to romantically connect to—unfortunately in such cases, the other party seldom communicates to the user the reason for the rejection, making improvement more difficult. What he'll typically do then is have someone else review his profile and get feedback about how he can improve it.

In the prior art application Ser. No. 14/244,904, we described a method by which a user could request explicit profile feedback from users meeting certain criteria. The method requires some effort from the part of the reviewers which they may not always be willing to give, even if appropriate compensation was provided. In this document, we propose a different method which allows such profiles to be automatically evaluated more directly by the target audience.

We use the word website to denote the set of all links contained within the same internet web domain. For example foo.com is a website associated with the URL http://foo.com/user1 or with URL http://mail.foo.com/otherlink/somethingelse.

We use the term profile and profile variant interchangeably. If a single user has multiple profiles we may refer to them as variants of each other.

### SUMMARY

This summary is meant to introduce a few concepts in a simplified form that are further described below in the Detailed Description. It is not intended to identify key features or essential features of the claimed subject matter, nor is it intended to be used as an aid in determining the scope of the claimed subject matter.

The premise of this application is that for social networking websites, online dating sites, business networking websites, it would be useful if there was a reliable way for users to improve their own profiles.

One embodiment for solving this problem follows: we propose a method by which a user can submit multiple versions of his own profile to the server, and the server can then randomly show a different version to users who view the profile and measure their interaction with it. For example, if user A submits two profiles P1 and P2 to represent his profile P, and his profile is viewed by 100 different people, the server could display P1 to 50 users and P2 to 50 other users, and measure how long the users in P1 spent on the profile versus the users in P2, thereby allowing user A to select one of the two profiles.

We take this one step further as well by allowing the user to decide which profile to show to which kind of people, or allowing the server to make the decision.

We describe several other embodiments in the detailed description and claims.

### Advantages

The advantages of such a system is that it allows users to get the most out of their profile by providing a set of metrics they are interested in optimizing and experimenting with several different profiles simultaneously to see what attracts their target audience's attention the fastest.

### DRAWINGS

FIG. 1 is a flow diagram that illustrates the step in which a user creates a plurality of user profiles for himself.

FIG. 2 is a flow diagram illustrating what happens when a different user attempts to access the first user's profile.

FIG. 3 is a diagram that illustrates the way user A retrieves engagement information about his multiple profiles.

FIG. 4 describes a basic social networking architecture as they are currently available on the market.

FIG. 5A shows part of the contents of one of the terminals used in FIG. 4.

FIG. 5B shows part of the contents of one of the servers used in FIG. 4.

FIG. 6 shows an alternative embodiment where the server automatically selects which user profile to show to the target.

### DETAILED DESCRIPTION

### First Embodiment

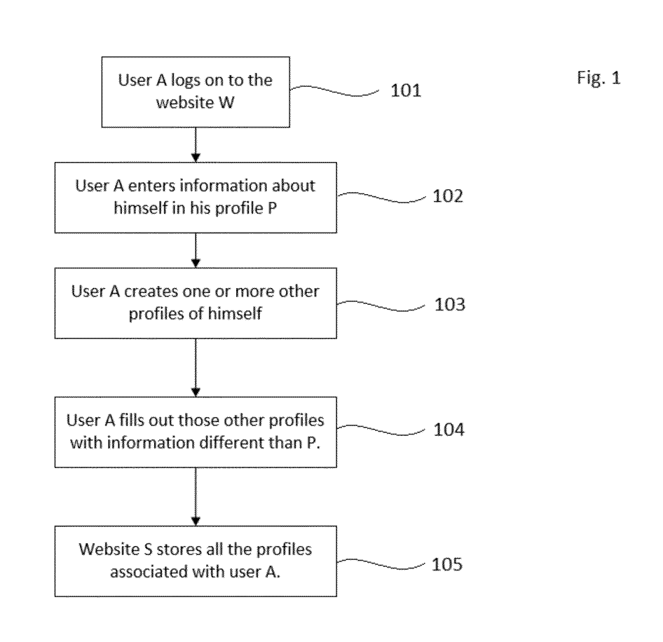

FIG. 1 shows a flow diagram that illustrates the step in which a user creates a plurality of user profiles for himself.

In the first step 101, the user A logs on to a website W under consideration. User A is then prompted to enter information about himself in his profile as described in step 102. Profile information was defined in the background section above. If user A had already entered such profile information at an earlier date, then step 102 is skipped and the user is taken to step 103. Otherwise, user A enters said information, website W stores said information into its web server database, and then user A is taken to step 103. The process thus far is typical of many online websites where users have profiles.

In step 103 however, the user is prompted to create different variants of his profile, and he fills them up in step 104. By variants here we mean different versions of the profile or of parts of the profile, that when shown to a third user would look like a profile. The variants are different in that they may have different text or image contents in them. For example, in an online business networking website, a user may have one profile where he is emphasizing his work experience, and another profile where he is emphasizing his extracurricular activities. In online dating, a user may have a profile variant which emphasizes his love of sports and all things sports-related, and another profile which emphasizes his more cultural side with a list of books he read recently and so on.

All the variants of the profile are stored on the website S server database in step 105. Once the user finishes entering them they are transmitted back to the server which assigns each profile variant a unique ID and maps it to the corresponding user.

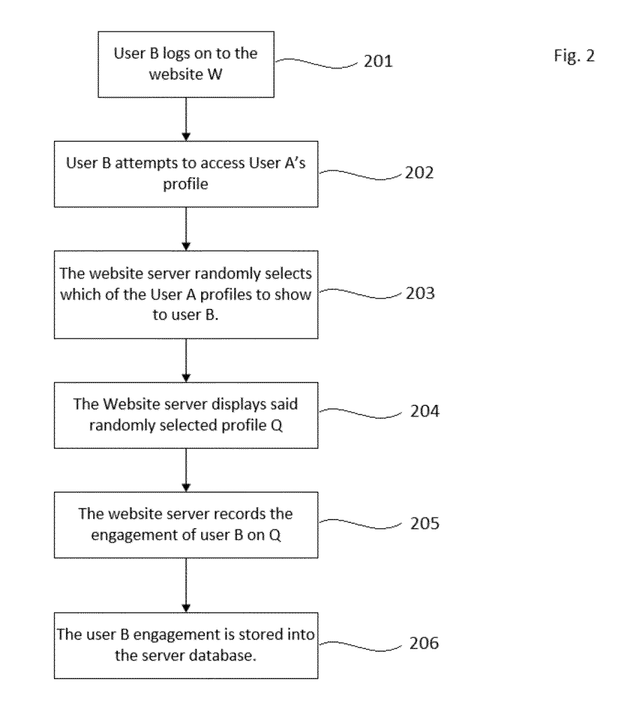

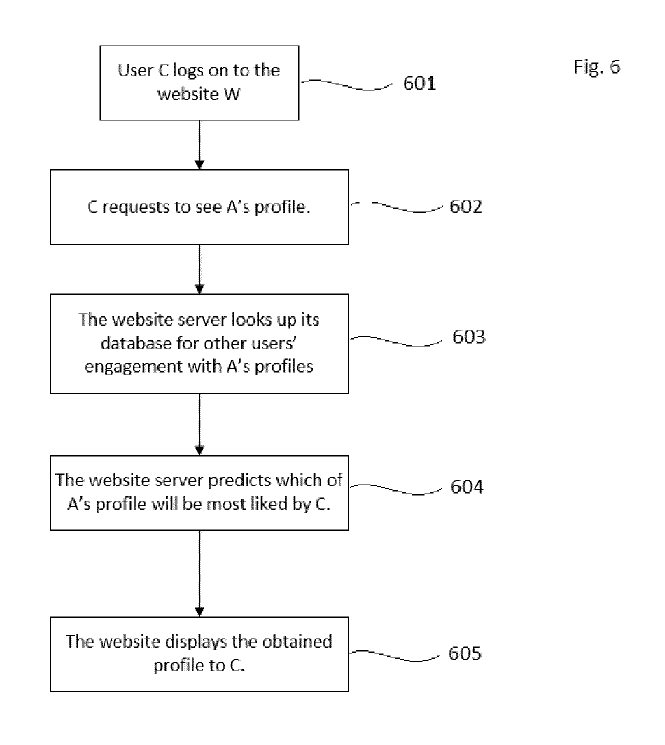

FIG. 2 describes what happens when a user B (who may be different from user A) logs into the website 201. If user B attempts to access user A's profile to view it (202), by sending a query to the web server, the web server looks up user A's profiles in its database (203). If there is only one such profile, it is displayed unaltered to user B as in 204. If there is more than one such profile, the web server selects one to show. This selection need not be entirely random and can be made to be persistent across certain users—some examples of selection could be: completely uniformly random profile, or count the number of letters in user B's username and run a math modulo operation with the number of A's profiles to pick one of A's profiles, or any other randomization or hashing method known. It can also be done in a more intelligent fashion as we will see shortly in FIG. 6, where certain properties of the viewing user are considered before picking which profile to show.

The selected profile Q is then displayed to user B (204).

From there, user B's behavior on profile Q is logged (205) and stored into the web server database (206). Behavior in this context is meant to be the set of actions (or non-actions) that user B takes while he is viewing profile Q—it comprises but is not limited to: whether user B, as a result of viewing profile Q, decided to contact user A; whether user B, as a result of viewing profile Q, decided to privately or publicly rate user A; how long user B remained on the profile Q web page before moving to another page; whether user B scrolled down all the way to the bottom of profile Q's page when reading it; as well as other metrics that are nowadays typically used to evaluate the quality of a page. We also use the word engagement information to refer to the above defined behavior information.

At that point, the web server gathers all the metrics for each of the profiles of user A. In one embodiment, it's possible for the web server to send an electronic mail to user A, displaying said engagement numbers in a detailed way, so that user A may make his own decisions based on them. The web server may choose to anonymize all the stored data by removing information about the identity of the users who visited user A's profile.

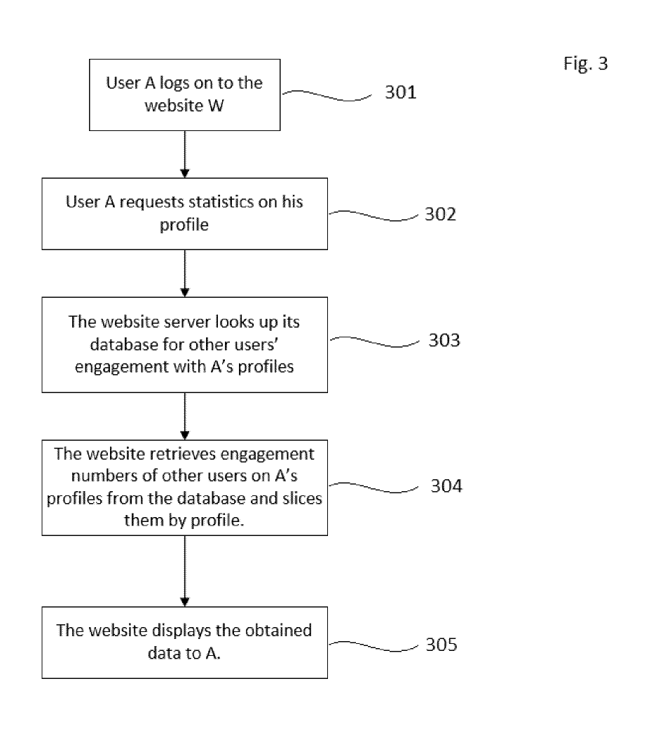

In another embodiment, as described in FIG. 3, user A logs on to the website W as shown in 301 and requests statistics about all his profile from the website (302). The website server then looks up its database for other users' engagement with A's profiles and retrieves them to its local memory as done in 303. Once the data is retrieved, the website can choose to display it as is in its raw format to user A (305), or it may choose to aggregate it on a per-profile basis. Raw format here means that for each profile visit, user A will be given engagement information about said profile visit. We also define what we mean by aggregating as follows. Let's assume user A had 3 profiles P1, P2, and P3, and each profile was visited 50 times. Instead of showing 150 entries for each of the visits, the web server would take the average of all the visits on P1, all the visits on P2, and finally on P3, yielding only 3 lines with a per-profile average. The definition of average here depends somewhat on what property is being measured—for example, if each profile measures the time users spent on the profile then the average here would be the average time spent on the profile by users who visited the profile.

The data is displayed to user A and he may use these numbers to select the most promising profile, or the one that most affects his target audience.

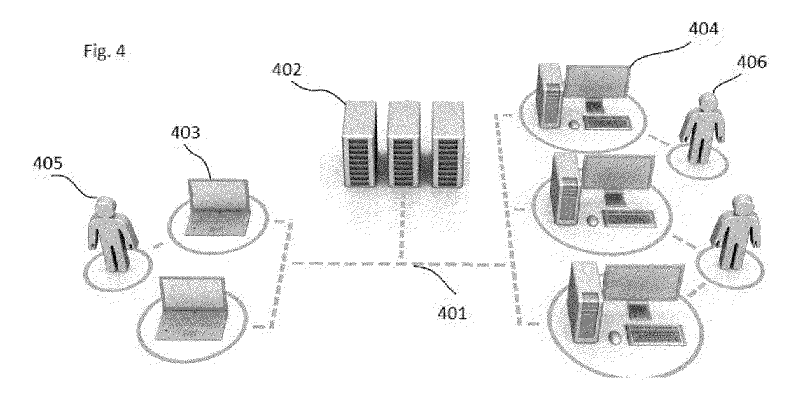

FIG. 4 shows a bit more information pertaining to the hardware involved. Such hardware is currently widespread and well understood and we are bringing it up for the sake of completeness. The method above is meant to run on a computing device such as a computer, server, phone, terminal or other devices. Users such as 405 and 406, through the use of their computing devices or terminals 403 and 404 respectively use the network or internet 401 to connect to one or more servers 402. 401 here could be the currently in-use internet, or a local area network, or a plain telephone system, or a wide area network. For a terminal to connect to the network they can use wired or wireless mediums which may be provisioned with routers and firewalls, but not limited to the above.

An example scenario with this architecture would be that user 405 through his use of computing device 403, connects to the server 402 and interfaces with his device to provide multiple variants of his profile. The device in turn relays information over the network 401 and such information is stored on the database of the server. Later on a user such as 406, through the use of his computing device attempts to read the profile of user 405 through his terminal. Server 402 looks up its database and uses its processing unit to select which profile is most suitable to show to 406, and returns the information to 406's computing device through the network.

406 later engages with the profile, and 406's terminal as well as 402 monitor how long it is before 406 leaves or interacts with the page. That data is stored into 402.

At a later time, 405 attempts to retrieve his profile statistics via 402. When that happens, the data is aggregated appropriately at 402 or returned raw as-is and displayed to 405.

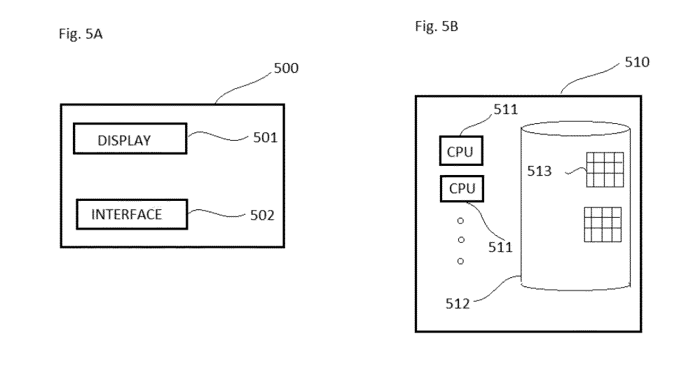

FIG. 5A is a diagram showing one embodiment of the terminal used by users. In this embodiment, the terminal 500 comprises a display system 501 as well as an interface 502 that allows its users to interact with it.

FIG. 5B is a diagram showing one embodiment of the server to which the terminals are connecting. The server 510 contains one or more processing units 511, as well as memory 512, which may be made up of one or more databases 513.

The above described the preferred embodiment, but there are several alternate embodiments which are described hereafter.

### Alternative Embodiments

We believe there are several ways to implement the overall system described above. The common factors are that a user on website W wants a simplified way to give his target audience the profile that would best promote him.

One such embodiment is described in FIG. 6. In this embodiment, C requests A's profile, and the web server S attempts to display to C the profile that S thinks will be the most interesting to C.

The description of this workflow is similar to that of the main embodiment so we will omit some of the details that have already been mentioned. As before, a user A has a plurality of profiles stored on the database of the website W's server S.

In 601, user C logs in and attempts to see A's profile (602). Where in the previous phase, the website server S was randomly selecting a profile to show C, this embodiment focuses instead of S trying to select the profile of A that will result in the most engagement with C.

In one embodiment, the server S looks up into its database and locates all the users that have interacted with A's profile. To make things clearer, we'll assume here again that user A has 3 profile variants on the website: P1, P2 and P3. Let's assume that over the past month, 50 different users have visited each of the profiles. All those users and their engagement and interaction numbers would already be stored in the server database. In step 603, the server looks up this information.

From this information, the server attempts to infer which of the profiles will be most liked by C, as shown in 604. This can be accomplished in a multitude of ways: the first way is to locate all the users who have visited each profile and who are similar to user C. By similar, we mean: within the same age range, or in the same industry, or some gender, or with similar descriptions about themselves. By similar description we refer to any of the techniques that are currently available for comparing the similarity between two documents. A similarity score is computed based on the above factors—the means of calculating said similarity scores are well documented in the literature. We've referenced one such published paper that's used to compute user similarity by Bhattacharyya in the non-patent literature section above, but the techniques are explained in other books and papers that have been published.

A second way of predicting which of A's profiles will be liked the most by C is by using a recommender system, also available in the literature. Essentially let U1, U2, . . . U150 be all the users who visited A's profile. One can predict how C will behave on A's profile by looking at all the other profiles that C looked at in the past, and comparing his behavior on said profiles to the behaviors of users U1 . . . U150 on those profiles. For example, assume C only visited the profile of X (which he loved) and of Y (which he didn't), and is now trying to visit A. U1, U2 have never visited X or Y. U5 has visited X and hated it, and visited Y and loved it; he also loved A's profile. U20 has visited X and loved it, and Y and didn't like it; he disliked A's profile. Then a recommender system would infer from this information that it is likely that C will also dislike the profile since he is similar in behavior to U20. Recommender systems are well understood in the literature, and are typically based on mathematical formulas such as matrix factorization and collaborative filtering. Essentially the product being recommended here is the profile variant—so given that a user C wants to visit A's profile, the recommendation system will find which of A's profiles will be most liked by C. An example of a publication about recommendation systems and collaborative filtering is the Sarwar et al. document attached in the non-patent literature.

Once the web server has established which profile is the most likely to be liked by C the most, it will display it to him as shown in 605.

The advantage of this method is that a user can now have multiple profiles on a website and not have to worry about maintaining a single perfect profile. Some profiles are catered towards certain kinds of people whereas other would be catered towards others, and the web server itself would attempt to optimize the experience as appropriate.

### CONCLUSIONS, RAMIFICATIONS AND SCOPE

Thus the reader will see that at least one embodiment of the system described above will allow users to easily expose multiple profiles of themselves and monitor other users' engagement with them. This would thereafter let them pick the profiles that performed the best.

While the above description contains many specificities, these should not be construed as limitations on the scope but rather as an exemplification of one or several embodiments thereof. Many other variations are possible. For example, it may be possible for the reviews to be hosted on a separate website—i.e. for a profile on website W, website R can be used to request reviews.

Accordingly, the scope should be determined not by the embodiments illustrated, but by the appended claims and their legal equivalents.

What is claimed is:

1. A computer-implemented method comprising:
receiving a plurality of user profiles from a first user, each user profile comprising characteristics of said first user;
receiving a request to view said first user's profile from a second user;
selecting a first profile from said plurality of profiles;
displaying said first profile to said second user.

2. The method of claim 1, wherein the selecting step is done through random uniform selection of a single first profile from said plurality of profiles.

3. The method of claim 1, further comprising:
monitoring and recording said second user's behavior on said profile.

4. The method of claim 3, wherein said behavior comprises: time spent on profile.

5. The method of claim 3, further comprising:
displaying said second user's behavior to said first user.

6. The method of claim 3, further comprising:
anonymizing said second user's behavior by removing said second user's identifying information;
displaying said anonymized behavior to said first user.

7. A computer-implemented method comprising:
receiving a plurality of user profiles from a first user, each user profile comprising characteristics of said first user;
receiving a request to view said first user's profile from a second user;
identifying said second user's behavior on a plurality of profiles of other users;
identifying a plurality of users who have interacted with at least one of the profiles from said plurality of profiles of other users;
selecting a first profile from said plurality of profiles based on said second user's estimated behavior on said first profile;
displaying said first profile to said second user.

8. The method of claim 7, further comprising:
displaying said second user's behavior to said first user.

9. The method of claim 7, further comprising
anonymizing said second user's behavior by removing said second user's identifying information;
displaying said anonymized behavior to said first user.

10. The method of claim 7 wherein the second user's estimated behavior is obtained by comparing said second user's profile characteristics to said plurality of users' characteristics.

11. A non-transitory computer-readable medium comprising instructions that, when executed by as processor with memory, are configured to at least:
receive a plurality of user profiles from a first user, each user profile comprising characteristics of said first user;
store said plurality of user profiles in said memory;
receive a request to view said first user's profile from a second user;
select a first profile from said plurality of user profiles in said memory;
display said first profile to said second user.

12. The medium of claim 11, wherein the select step is done through random uniform selection of a single first profile from said plurality of profiles.

13. The medium of claim 11, where the instructions are further configured to:
monitor said second user's behavior;
store said second user's behavior in said memory.

14. The medium of claim 13, where the instructions are further configured to:
display said second user's behavior to said first user.

15. The medium of claim 13, where the instructions are further configured to:
aggregate said second user's behavior with a plurality of other users' behaviors on said first user profile.
